(19) United States
(12) Patent Application Publication
(10) Pub. No.: US 2005/0004887 A1
(43) Pub. Date: Jan. 6, 2005

(54) Policy processing system and method

(75) Inventors: Tomohiro Igakura, Tokyo (JP); Toshio Tonouchi, Tokyo (JP)

Correspondence Address: MCGINN & GIBB, PLLC, 8321 OLD COURTHOUSE ROAD, SUITE 200, VIENNA, VA, 22182-3817, US

(73) Assignee: NEC Corporation, Tokyo (JP)

(21) Appl. No.: 10/880,573

(22) Filed: Jul. 1, 2004

(30) Foreign Application Priority Data
Jul. 2, 2003 (JP) 2003-190493

(51) Int. Cl. H04L 1/22

(52) U.S. Cl. 707/1

(57) ABSTRACT

A policy processing system includes a storage section for storing a plurality of policies and a policy transition processor. Each of policies includes policy transition information including at least one transition-destination policy for a corresponding policy. Policy transition is performed such that, when a policy is activated due to occurrence of an event that matches the policy, the policy activated is changed to a corresponding transition-destination policy according to the policy transition information of the policy activated.

### BACKGROUND OF THE INVENTION

1. Field of the Invention

The present invention relates to a rule based policy processing technique of controlling the routing destination of a message, and particularly relates to a policy processing system and policy processing method that involve policy transition.

2. Description of the Related Art

A conventional policy processing technique for controlling the routing destination of a message based on a policy is used in a device providing automatic management of machines connected by a network, and is designed to determine what sort of operation is to be performed in which machine for each occurring event such that an event such as an error occurs in a network, machine, service that operates on a machine, or other object to be managed.

A “policy,” as referred to herein, is generally defined as including a trigger condition, which is a definition of an event denoting a condition that causes an operation, and also including the definition of an actual operation, and post-activation operation information that is the object of the operation. A possible example thereof is a policy whereby a time is specified and the operation of a service is changed. A policy is also possible whereby a usual service is performed from 8:00 pm to 9:00 pm and the service is stopped during other times to analyze a log of the service thus provided.

Another example is an instrument whereby the service to be used is determined from the user, the service requested by the user, and various other information for an event referred to as a service request generated by the user, and the service request is transferred to the corresponding service.

There has been known as a conventional technique for describing a policy “Ponder” disclosed in Lecture Notes in Computer Science, Policy for Distributed Systems and Networks, January 2001, pp. 18-38, The Ponder Policy Specification Language, Nicodemos Damianou, Naranker Dulay, Emil Lupu, Morris Sloman.

“Ponder” is a language for describing a policy, and this language is used to set an operation, the object thereof, and the subject for performing the operation according to an event and a condition. In other words, by means of “Ponder,” a policy is described that uses “who does what to whom and in what case” as a unit, and an operation is performed on the basis of that description.

In a policy processing system using “Ponder”, an operation for an event can be described in “Ponder” in the form of Obligation Policy. Furthermore, “when a function is operating” and other states of an external instrument or the like can be described using the keyword “when” as the condition for activating a policy.

For example, a policy retrieval section receives an event from an event-receiving section, whereupon the status of an external instrument described by “when” is requested of a status variable management section. The status variable management section inquires of an external instrument as to the status via a status acquiring section, and notifies the policy retrieval section of the status information in the response. The policy retrieval section retrieves a policy on the basis of this status information and the event received from the event-receiving section.

However, in the conventional technique described above, policies describing the operations for respective statuses are all prepared, and the policy retrieval section must select from all of the policies a policy for which the trigger condition matches the event and for which the status of the external instrument matches the condition indicated by “when.” Consequently, drawbacks exist whereby the time required for the policy retrieval process increases because of an increasing number of policies targeted for retrieval.

There has been proposed a network management system which can respond to a change in status by changing the policy according to a change in the status of the network. An example of such a conventional technique is disclosed in Japanese Laid-open Patent Application No. 2002-111729. Such a conventional policy processing system monitors network traffic and changes an operation parameter of the policy when the parameter exceeds a preset threshold value. However, changing the type of the parameter used as a trigger by the policy or changing the operating target thereof is not possible in this technique, and the number of policies also cannot be increased or reduced.

The condition for changing a policy and the policy to be changed are also separate entities. For example, the conventional technique cannot accommodate a change to the policy itself on the basis of an operation that is set by the policy, such as when an “activate service” policy changes to a “stop service” policy after activation.

Accordingly, the conventional techniques described above have such drawbacks as the following.

First, no functionality is provided for performing processing such as implementing a policy change or a change in a combination of operable policies on the basis of an occurring event or a change in status due to the post-activation operation of a policy in response to the event; for example, changing the operation of a policy or a combination of activatable policies in a normal or abnormal state.

Second, since policy trigger conditions or policies with different operations must all be prepared according to statuses, the number of policies to be retrieved increases. In some cases policies exist whereby it is known in advance from the status that an event corresponding to the trigger will not occur. In such a case, invalid policies are also retrieved, increasing the processing time required for retrieving the policy that corresponds to the event.

### SUMMARY OF THE INVENTION

An object of the present invention is to provide policy processing system and method wherein a policy change and a change in a combination of operable policies can be automatically performed by presetting on the basis of an occurring event or a change in status due to the post-activation operation of a policy in response to the event.

Another object of the present invention is to provide policy processing system and method wherein the processing time needed for retrieval can be reduced by causing only the currently operating policy to be targeted for policy retrieval when the event occurs in a state of an instrument managed by the policy, an instrument issuing an event, or the like.

A policy processing system according to the present invention for achieving the above-mentioned objects is characterized by comprising: a storage section for storing a plurality of policies, wherein each of the plurality of policies includes policy transition information including at least one transition-destination policy for a corresponding policy; and a policy transition process or performing policy transition such that, when a policy is activated due to occurrence of an event that matches the policy, the policy activated is changed to a corresponding transition-destination policy according to the policy transition information of the policy activated.

More specifically, information is stored including a trigger condition indicating a condition for an event that acts as a trigger for activating a policy, a post-activation operation indicating an operation to be performed after the policy is activated, and zero or more destination policies for each policy, and after the policy is activated in response to an occurrence of an event that matches the corresponding trigger condition, the policy thus activated is changed to the destination policy.

The policy processing system may include: a policy database for storing a trigger condition and a post-activation operation for each of a plurality of policies; a policy transition database for storing policy transition information for a policy that is associated with at lease one transition-destination policy; a destination policy retrieval section for retrieving from the policy transition database a transition-destination policy based on the policy transition information for a policy that is activated due to occurrence of an event that matches a trigger condition of the policy; and a policy-changing section for changing the policy activated to the transition-destination policy retrieved in the policy database.

The policy processing system may further include: a policy retrieval section for retrieving a policy having a trigger condition matching an event from the policy database to activate the policy; and an operation execution section for executing the post-activation operation of the policy activated.

The policy transition database may include: a transition flag table for storing transition flags for respective ones of the plurality of policies, wherein a transition flag indicates whether a corresponding policy is associated with at lease one transition-destination policy; and a destination policy table for storing a trigger condition and a post-activation operation for each transition-destination policy.

As different embodiments, the policy transition information may include a policy generation rule for generating a transition-destination policy from the policy activated. Specifically, the policy transition database includes: a transition flag table for storing transition flags for respective ones of the plurality of policies, wherein a transition flag indicates whether a corresponding policy is associated with at lease one transition-destination policy; and a policy generation rule table for storing a policy generation rule comprising a trigger condition generation rule and a post-activation operation generation rule.

The policy-changing section may include: a policy deletion section for deleting the policy activated from the policy database; and a policy addition section for adding the transition-destination policy retrieved to the policy database.

According to another embodiment, the policy transition information may include policy group information under which a plurality of policies is grouped, wherein the policy-changing section deletes a group of policies including the policy activated from the policy database.

According to still another embodiment, the policy database may further store an effectiveness flag for each of the plurality of policies, wherein among a plurality of policies having the effectiveness flag that has been set, a policy activated due to occurrence of an event that matches a trigger condition of the policy is retrieved. The policy-changing section resets the effectiveness flag of the policy activated to ineffective, and sets the effectiveness flag of the transition-destination policy retrieved to effective.

According to further embodiment, the policy transition database may include: a destination policy table for storing a trigger condition and a post-activation operation for each transition-destination policy; and a transition location table for storing transition flags and transition locations for respective ones of the plurality of policies, wherein a transition flag indicates whether a corresponding policy is associated with at lease one transition-destination policy and a transition location indicates a location of at lease one transition-destination policy in the destination policy table, wherein the trigger condition and the post-activation operation for a single transition-destination policy are usable for a plurality of policies in the transition location table.

According to still further embodiment, a policy processing system includes: a policy database for storing a plurality of policies to be retrieved; a policy group table storing policy group information under which a plurality of policies is grouped; a policy group transition table storing transition-destination policy group information for a policy that is associated with at lease one transition-destination policy; a destination group retrieval section for retrieving from the policy group transition table a transition-destination policy group based on the transition-destination policy group information for a policy that is activated due to occurrence of an event that matches the policy; a policy group retrieval section for retrieving from the policy group table a policy group including the a policy that is activated due to occurrence of an event that matches the policy; and a policy-changing section for changing policies belonging to the policy group retrieved to policies belonging to the transition-destination policy group retrieved in the policy database.

According to still another embodiment, a policy processing system includes: a policy database for storing a plurality of policies; an effective policy group table for storing an effective group; a policy group transition table storing transition-destination policy group information for a policy that is associated with at lease one transition-destination policy; a policy retrieval section for retrieving a policy that is activated due to occurrence of an event that matches the policy from the effective group of policies stored in the policy database; and a policy changing section for changing the effective group in the effective policy group table from the group including the policy activated to a transition-destination policy group including a transition-destination policy associated with the policy activated, based on the transition-destination policy group information.

According to the present invention, a policy processing method and a computer program instructing a computer to implement a policy processing system, includes the steps of: storing a trigger condition and a post-activation operation for each of a plurality of policies into a policy database; storing policy transition information for a policy that is associated with at lease one transition-destination policy into a policy transition database; retrieving from the policy transition database a transition-destination policy based on the policy transition information for a policy that is activated due to occurrence of an event that matches a trigger condition of the policy; and changing the policy activated to the transition-destination policy retrieved in the policy database.

Such advantages as described below are obtained according to the policy processing system and processing method of the present invention as heretofore described.

A first advantage is that a change to another policy can be automatically performed after activation of a policy that corresponds to an occurring event, and the changed policy can be freely determined for each policy. As a result, it becomes possible to describe in advance the change in policy brought about by the effects of the occurring event and the operation caused by activation of the policy. This is because information about the policy to which the current policy is changed to after being activated is stored in a policy transition database, the changed policy is retrieved from the policy transition database by using the policy information activated according to the occurrence of the event as a key, and the policy in the policy database is substituted.

A second advantage is that the specific parameters of the changed policy can be determined in accordance with the detailed parameters of the occurring event. As a result, there is no need to prepare destination policies for each of the various parameters of an event, and parameters of unpredictable events can be accommodated. This is because a policy generation rule can be stored as a changed policy in the policy transition database, a policy is generated from the policy generation rule and the occurring event, and the original unchanged policy stored in the policy database is substituted with the generated policy.

A third advantage is that when original policies to be changed are collected in a group and any of the policies in the group are changed, the policies contained in the group are simultaneously deleted. As a result, it becomes possible to simultaneously change a plurality of interrelated policies. This is because a policy group table in which a plurality of policies are collected in a group is held in the policy transition database, and when a policy is changed, all of the policies belonging to the same group are retrieved from the policy group table with the original unchanged policy as a key, and all of the policies thus retrieved are deleted from the policy database.

### BRIEF DESCRIPTION OF THE DRAWINGS

FIG. 1 is a block diagram depicting the configuration of a policy processing system according to Embodiment 1 of the present invention;

FIG. 2 is a flowchart describing the operation of the, policy processing system according to Embodiment 1 of the present invention;

FIG. 3 is a block diagram depicting the configuration of the policy processing system according to Embodiment 2 of the present invention;

FIG. 4 is a flowchart describing the operation of the policy processing system according to Embodiment 2 of the present invention;

FIG. 5 is a block diagram depicting the configuration of the policy processing system according to Embodiment 3 of the present invention;

FIG. 6 is a flowchart describing the operation of the policy processing system according to Embodiment 3 of the present invention;

FIG. 7 is a block diagram depicting the configuration of the policy processing system according to Embodiment 4 of the present invention;

FIG. 8 is a flowchart describing the operation of the policy processing system according to Embodiment 4 of the present invention;

FIG. 9 is a block diagram depicting the configuration of the policy processing system according to Embodiment 5 of the present invention;

FIG. 10 is a flowchart describing the operation of the policy processing system according to Embodiment 5 of the present invention;

FIG. 11 is a block diagram depicting the configuration of the policy processing system according to Embodiment 6 of the present invention;

FIG. 12 is a flowchart describing the operation of the policy processing system according to Embodiment 6 of the present invention;

FIG. 13 is a block diagram depicting the configuration of the policy processing system according to Embodiment 7 of the present invention;

FIG. 14 is a block diagram depicting the configuration of the policy processing system according to Embodiment 8 of the present invention;

FIG. 15 is a block diagram depicting the configuration of the policy processing system according to Embodiment 9 of the present invention;

FIG. 16 is a block diagram depicting the configuration of the policy processing system according to Embodiment 10 of the present invention;

FIG. 17 is a block diagram depicting the configuration of the policy processing system according to Embodiment 11 of the present invention;

FIG. 18 is a flowchart describing the operation of the policy processing system according to Embodiment 11 of the present invention;

FIG. 19 is a block diagram depicting the configuration of the policy processing system according to Embodiment 12 of the present invention;

FIG. 20 is a flowchart describing the operation of the policy processing system according to Embodiment 12 of the present invention;

FIG. 21 is a block diagram depicting the configuration of the policy processing system according to Embodiment 13 of the present invention;

FIG. 22 is a diagram depicting a specific example of the policy database according to Working Example 1 of the present invention;

FIG. 23 is a diagram depicting a specific example of the transition flag table according to Working Example 1 of the present invention;

FIG. 24 is a diagram depicting a specific example of the destination policy table according to Working Example 1 of the present invention;

FIG. 25 is a diagram depicting a specific example of the policy database according to Working Example 2 of the present invention;

FIG. 26 is a diagram depicting a specific example of the policy generation rule table according to Working Example 2 of the present invention;

FIG. 27 is a diagram depicting a specific example of the policy group table according to Working Examples 3 and 4 of the present invention;

FIG. 28 is a diagram depicting a specific example of the policy database according to Working Example 5 of the present invention;

FIG. 29 is a diagram depicting a specific example of the transition location table according to Working Example 6 of the present invention; and

FIG. 30 is a diagram depicting a specific example of the destination policy table according to Working Example 6 of the present invention.

### DESCRIPTION OF THE PREFERRED EMBODIMENTS

Embodiment 1

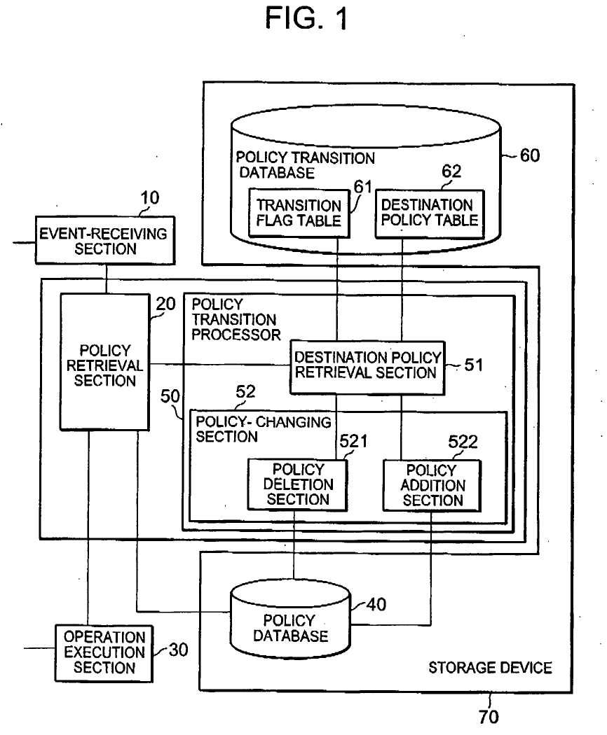

Referring to FIG. 1, a policy processing system according to a first embodiment of the present invention includes an event-receiving section 10 as an interface for receiving notification of the occurrence of an event from outside; a policy retrieval section 20 for retrieving and activating a policy in which a trigger condition matches the event received by the event-receiving section 10; a memory, hard disk, or other storage device 70; an operation execution section 30 for executing the at-activation-time operation of the policy activated by the policy retrieval section 20; and a policy transition processor 50 for performing a policy transition for the policy activated by the policy retrieval section 20.

The storage device 70 includes a policy database 40 for storing policies to be retrieved by the policy retrieval section 20, and a policy transition database 60 for storing policy transition rules.

The policy database 40 stores policy information that includes both a trigger condition, which means an event that becomes a condition for activation of a policy, and an at-activation-time operation that indicates the operation executed when the policy is activated and the object thereof. The term “trigger condition” refers to a condition that specifies the type of an event and the range of parameters thereof. Specific examples of a trigger condition are as follows: “when the time is 8:00 am;” and “when a request is issued for service A by an authenticated user.”

The policy retrieval section 20 retrieves from the policy database 40 a policy that matches the trigger condition for the event received by the event-receiving section.

The policy transition database 60 is provided with a transition flag table 61 and a destination policy table 62.

The transition flag table 61 stores a flag indicating whether or not a transition will occur after policy activation, identification information such as ID identifying one or more destination policies for a policy having the flag indicating that a transition will occur, and other information. The destination policy table 62 stores a trigger condition and an at-activation-time operation for each destination policy.

The policy transition processor 50 is provided with a destination policy retrieval section 51 and a policy-changing section 52. The destination policy retrieval section 51 searches the transition flag table 61 for the policy retrieved by the policy retrieval section 20 and inquires whether or not a destination policy is set for that policy. When a destination policy is set for that policy, the destination policy retrieval section 51 retrieves the destination policy from the destination policy table 62.

The policy-changing section 52 is provided with a policy deletion section 521 and a policy addition section 522. The policy deletion section 521 receives information about the original pre-transition policy from the destination policy retrieval section 51 and deletes the original pre-transition policy from the policy database 40. The policy addition section 522 acquires the destination policy retrieved by the destination policy retrieval section 51 and adds it to the policy database 40.

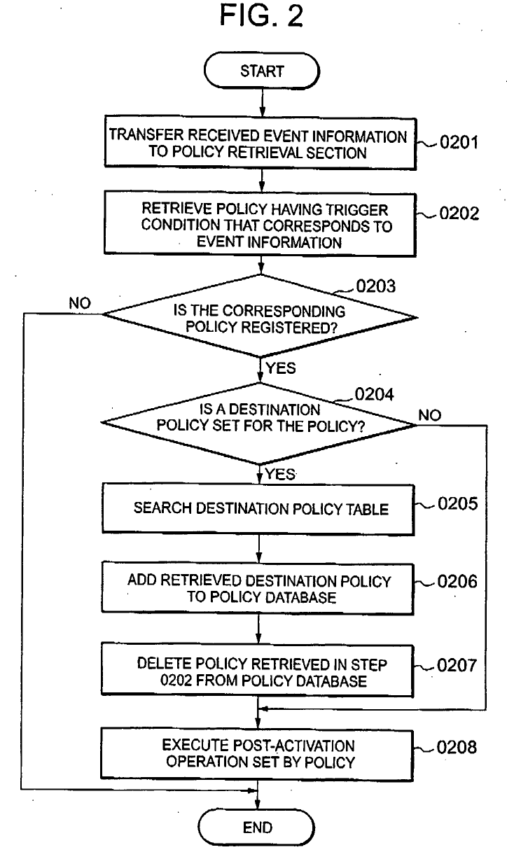

An operation of the first embodiment will next be described in detail with reference to FIG. 2.

Referring to FIG. 2, event information received by the event-receiving section 10 is transferred to the policy retrieval section 20 (step 0201). The policy retrieval section 20 retrieves from the policy database 40 a policy having a trigger condition that matches the event information (step 0202).

When such a policy that matches the event information has been retrieved (YES in step 0203), the policy retrieval section 20 notifies the destination policy retrieval section 51 of the policy thus retrieved. The destination policy retrieval section 51 searches the policy transition database 60 using as a key the policy transferred from the policy retrieval section 20. The transition flag table 61 is first searched for this policy to check a flag indicating the presence of a destination policy (step 0204).

When the flag indicates that a destination policy is present, the transition flag table 61 is searched, information is acquired specifying the destination policy set for this policy, the destination policy table 62 is searched using this information as a key, and the trigger condition and post-activation operation of the destination policy are acquired (step 0205).

The destination policy retrieval section 51 then notifies the policy addition section 522 of the destination policy information composed of: information specifying the destination policy acquired in the step 0205; and trigger condition and post-activation operation thereof. The policy addition section 522 adds the acquired destination policy to the policy database 40 (step 0206).

The destination policy retrieval section 51 then notifies the policy deletion section 521 of the policy transferred from the policy retrieval section 20. The policy deletion section 521 deletes from the policy database 40 the policy thus received (step 0207)- It should be noted that the order of processing in steps 0206 and 0207 may also be reversed.

If it is known subsequently or in step 0204 that there is no destination policy (NO in step 0204), then the policy retrieval section 20 transfers the retrieved policy to the operation execution section 30. The operation execution section 30 executes the post-activation operation that is set by the policy (step 0208).

Only one policy was activated for the event in the present embodiment, but when there is a plurality of policies activated, the operations following the step 204 can be executed by repeating as many times as the number of policies activated.

The advantages of the first embodiment described above will next be described. According to the present embodiment, a policy transition for the policy activated by the event is previously set and thereby the policy can be changed according to the post-activation operation that is set by the policy or the event that activated the policy.

Embodiment 2

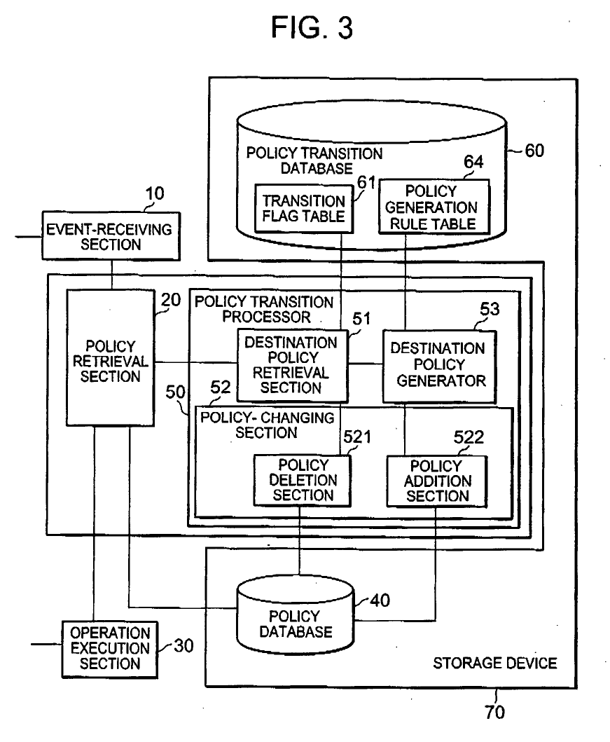

Referring to FIG. 3, the policy processing system according to a second embodiment of the present invention differs in that the policy transition processor 50 has a destination policy generator 53 in addition to the configuration of the policy transition processor 50 in the first embodiment depicted in FIG. 1, and further differs in that the policy transition database 60 has no destination policy table 62 and has a policy generation rule table 64 in contrast to the configuration of the policy transition database 60 of the first embodiment depicted in FIG. 1.

The policy generation rule table 64 stores policy generation rules, each of which is a rule for generating a policy. The term “policy generation rule” herein refers to a rule for generating a policy by using an event value acquired by the event-receiving section 10.

Specific examples of policy generation rules are as follows: “perform operation three hours after event occurs,” “execute a service requested by an event when there is a service request from a user name instructing that an event occur,” and the like.

As one example, the policy “perform operation at 12:00 pm” is generated from the policy generation rule “perform operation three hours after an event occurs” and the event “9:00 am.”

As another example, the policy “execute Service B when there is a request from User A” is generated from the policy generation rule “execute a service requested by an event when there is a request from a user name instructing that an event occur” and the event “User A reserves Service B.”

The destination policy generator 53 creates a policy on the basis of the policy generation rule retrieved by the destination policy retrieval section 51, event information received by the event-receiving section 10, and information relating to the event (for example, the time at which the event occurred, the origin from which the event occurred, the function requested by the event, the parameter value transferred to the function, and other information). Thereafter, the destination policy generator 53 transfers the created policy to the policy addition section 522.

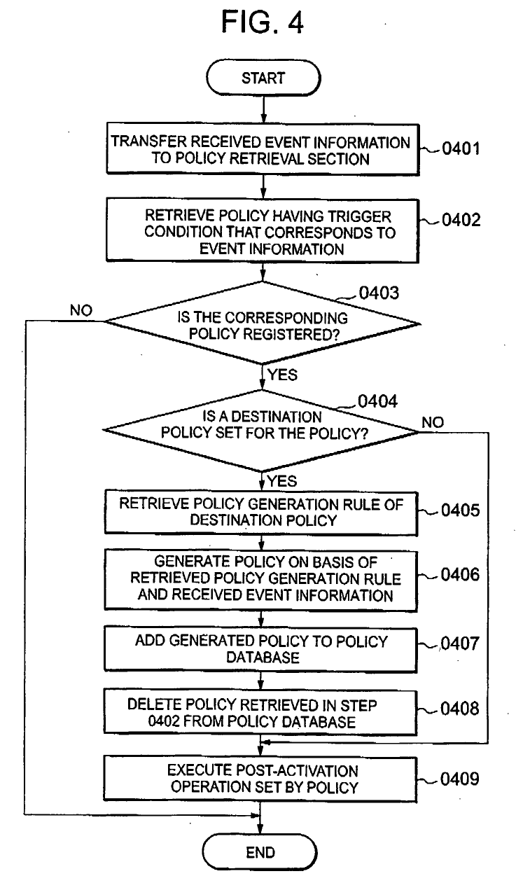

An operation of the above-mentioned Embodiment 2 will next be described in detail with reference to FIG. 4.

Referring to FIG. 4, the operations of the event-receiving section 10, policy retrieval section 20, and policy transition processor 50 in the present embodiment shown in steps 0401 through 0404 of FIG. 4 are the same as the operations of the event-receiving section 10, policy retrieval section 20, and policy transition processor 50 shown in steps 0201 through 0204 of FIG. 2, in which the operation of the first embodiment is shown. Accordingly, the descriptions thereof are omitted.

The operations of the policy transition processor 50 and operation execution section 30 in the present embodiment, which are depicted in steps 0407 through 0409 of FIG. 4, are also the same as the operations of the policy transition processor 50 and operation execution section 30 depicted in steps 0207 through 0208 of FIG. 2, which shows the operation of the first embodiment, so the descriptions thereof are also omitted.

As described before, in the first embodiment, the destination policy retrieval section 51 retrieves the destination policy from the policy transition database 60. In contrast, according to the second embodiment, the destination policy retrieval section 51 acquires from the transition flag table 61 information such as ID specifying the destination policy, and transfers that information to the destination policy generator 53.

The destination policy generator 53 searches the policy generation rule table 64 using the policy information transferred form the destination policy retrieval section 51 as a key (step 0405).

The destination policy generator 53 then generates a policy on the basis of the policy generation rule thus retrieved and the event received by the event-receiving section 10 in step 0401 and transfers the policy thus generated to the policy addition section 522 (step 0406).

According to the above-mentioned second embodiment, it is possible to set a specific value for the destination policy according to the specific details of the generated event, and as a result, fine differences in events can be reflected in the destination policy.

Embodiment 3

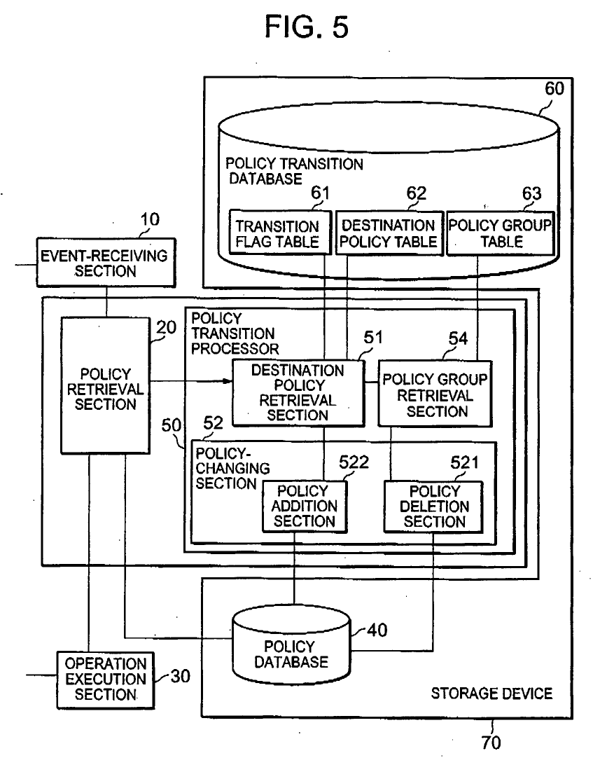

Referring to FIG. 5, the policy processing system according to a third embodiment of the present invention differs in that the policy transition processor 50 has a policy group retrieval section 54 in addition to the configuration of the policy transition processor 50 in the first embodiment depicted in FIG. 1, and further differs in that the policy transition database 60 has a policy group table 63 in addition to the configuration of the policy transition database 60 in the first embodiment depicted in FIG. 1.

The policy group table 63 stores information such as ID that identifies a group for each policy. A plurality of policies may have information identifying the same group.

The policy group retrieval section 54 receives a pre-transition policy from the destination policy retrieval section 51. The policy group retrieval section 54 searches the policy group table 63 using this received policy as a key to find the group to which this received policy belongs, and further searches the policy group table 63 using this group as a key to retrieve all of the policies belonging to this group. All of the policies belonging to this group are transferred to the policy deletion section 521. The policy deletion section 521 deletes from the policy database 40 all of the policies thus received.

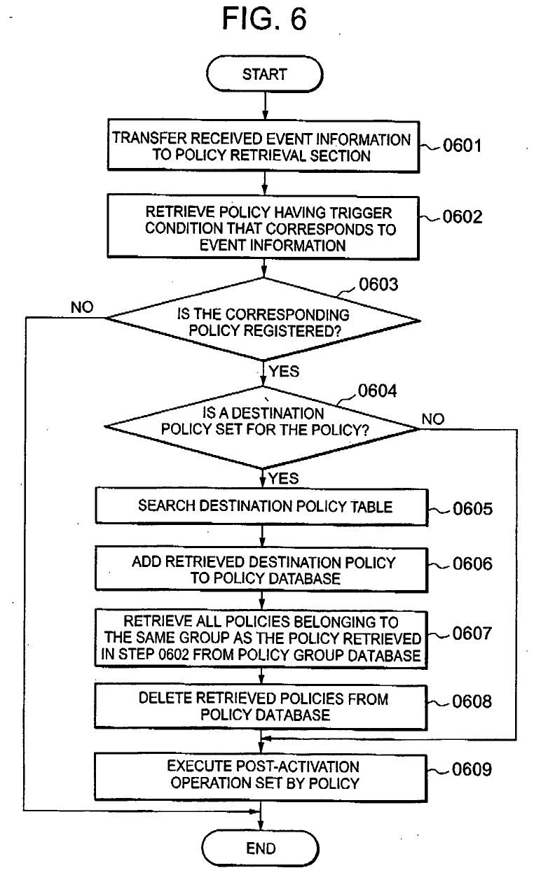

An operation of the above-mentioned third embodiment will next be described in detail with reference to FIG. 6.

Referring to FIG. 6, the operation of the event-receiving section 10, policy retrieval section 20, and policy transition processor 50 in the present embodiment, which is depicted in steps 0601 through 0606 in FIG. 6, is the same as the operation of the event-receiving section 10, policy retrieval section 20, and policy transition processor 50 depicted in steps 0201 through 0206 in FIG. 2, which shows the operation of the first embodiment, so description thereof is omitted.

The operation of the policy transition processor 50 and operation execution section 30 in the present embodiment depicted in step 0609 in FIG. 6 is also the same as the operation of the policy transition processor 50 and operation execution section 30 depicted in step 0208 in FIG. 2, which shows the operation of the first embodiment, so description thereof is omitted.

As described before, in the first embodiment, the destination policy retrieval section 51 transferred to the policy deletion section 521 the policy received from the policy retrieval section 20. In contrast, according to the third embodiment, the destination policy retrieval section 51 transfers to the policy group retrieval section 54 the policy received from the policy retrieval section 20.

The policy group retrieval section 54 searches the policy group table 63 using the policy received from the destination policy retrieval section 51 as a key to find the group to which this policy belongs. The policy group table 63 is then searched using this policy group as a key and thereby all of the policies belonging to this group are retrieved.

All of the policies thus retrieved are transferred to the policy deletion section 521 (step 0607). The policy deletion section 521 deletes from the policy database 40 all of the policies received from the policy group retrieval section 54 (step 0608).

According to the present embodiment, it becomes possible to specify a plurality of policies as an object for policy deletion, so it becomes possible to simultaneously change related policies, for example, relating to the same instrument.

Embodiment 4

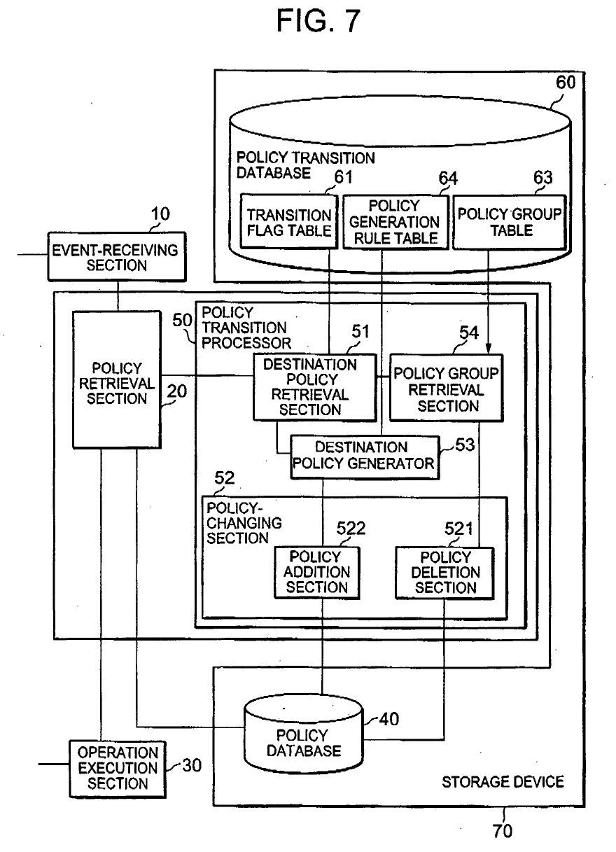

Referring to FIG. 7, the policy processing system according to a fourth embodiment of the present invention differs in that the policy transition processor 50 has a policy group retrieval section 54 in addition to the configuration of the policy transition processor 50 in the first embodiment depicted in FIG. 1, and further differs in that the policy transition database 60 has a policy group table 63 in addition to the configuration of the policy transition database 60 in the first embodiment depicted in FIG. 1.

The policy group retrieval section 54 receives an original pre-transition policy from the policy retrieval section 51. The policy group retrieval section 54 searches the policy group table 63 using the received pre-transition policy as a key to find the group to which the received pre-transition policy belongs. Further the policy group table 63 is searched using the found group as a key to retrieve all of the policies belonging to this group. All of the policies belonging to this group are transferred to the policy deletion section 521.

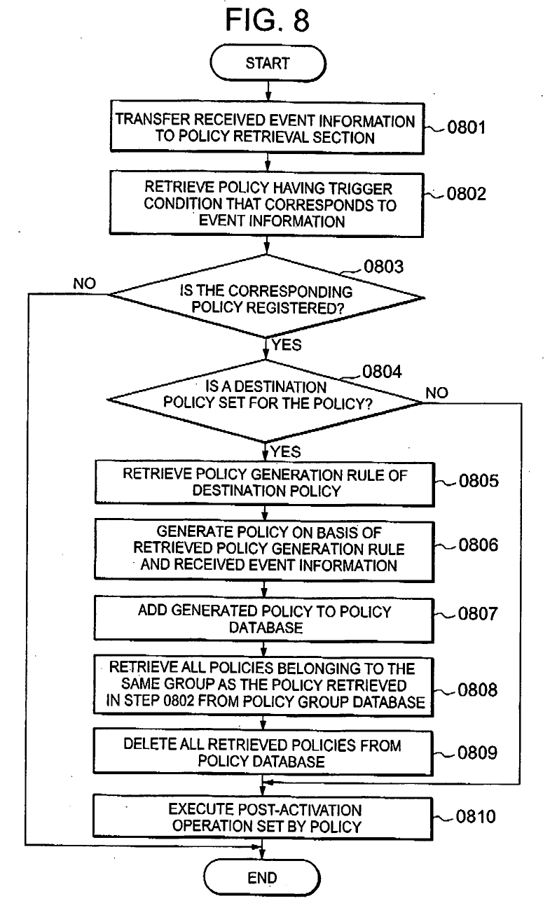

An operation of fourth embodiment will next be described in detail with reference to FIG. 8.

Referring to FIG. 8, the operations of the event-receiving section 10, policy retrieval section 20, and policy transition processor 50 in the present embodiment depicted in steps 0801 through 0807 in FIG. 8 are the same as those of the event-receiving section 10, policy retrieval section 20, and policy transition processor 50 depicted in steps 0401 through 0407 in FIG. 4, which shows the operations of the second embodiment, so description thereof is omitted.

The operation of the policy transition processor 50 and operation execution section 30 in the present embodiment depicted in step 0810 in FIG. 8 is also the same as the operation of the policy transition processor 50 and operation execution section 30 depicted in step 0409 in FIG. 4, which shows the operation of the second embodiment, so description thereof is omitted.

As described before, in the second embodiment, the destination policy retrieval section 51 transferred to the policy deletion section 521 the policy received from the policy retrieval section 20. In contrast, according to the fourth embodiment, the destination policy retrieval section 51 transfers to the policy group retrieval section 54 the policy received from the policy retrieval section 20.

The policy group retrieval section 54 searches the policy group table 63 using the policy received from the destination policy retrieval section 51 as a key to find the group to which this received policy belongs. The policy group table 63 is then searched using this policy group as a key and thereby all of the policies belonging to this group are retrieved. All of the policies thus retrieved are transferred to the policy deletion section 521 (step 0808).

The policy deletion section 521 deletes from the policy database 40 all of the policies received from the policy group retrieval section 54 (step 0809).

The advantages of the above-mentioned Embodiment 4 will next be described. In addition to the effects of the second embodiment, it becomes possible by means of the present embodiment to specify a plurality of policies as a target for policy deletion, whereby related policies, for example, relating to the same instrument and other types of multiple interrelated policies, can be changed at the same time.

Embodiment 5

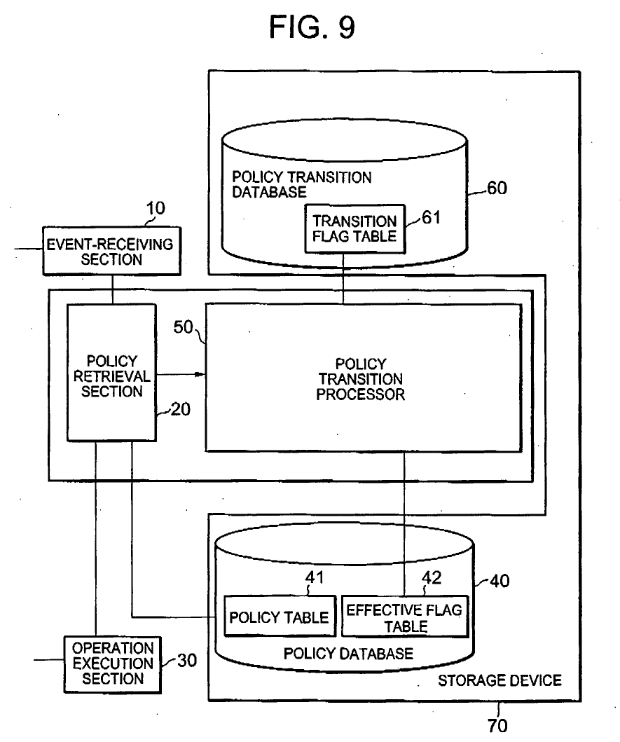

Referring to FIG. 9, the policy processing system according to a fifth embodiment of the present invention differs in having a policy table 41 and an effective flag table 42, compared to the configuration of the policy database 40 in the configuration of the first embodiment. In contrast with the configuration of the policy transition database 60 in the first embodiment depicted in FIG. 1, the policy processing system according to the fifth embodiment also differs in the policy transition database 60 having no destination policy table 62. The configuration of the policy transition processor 50 is the same as that of the first embodiment depicted in FIG. 1.

The policy table 41 stores information equivalent to the information stored by the policy database in the first embodiment The effective flag table 42 stores a flag that indicates effectiveness or ineffectiveness for each policy.

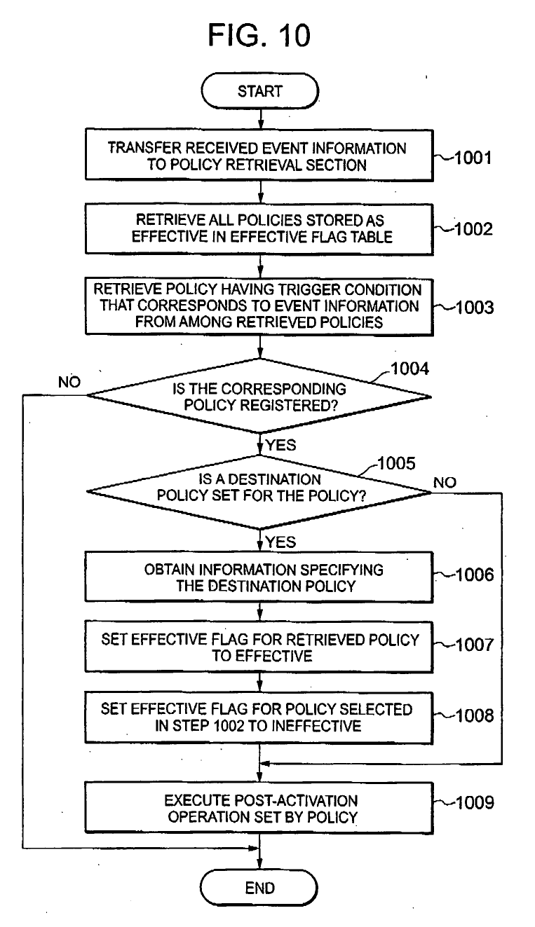

An operation of the fifth embodiment will next be described in detail with reference to FIG. 10.

Referring to FIG. 10, the operation of the event-receiving section 10 in the present embodiment depicted in step 1001 of FIG. 10 is the same as the operation of the event-receiving section 10 depicted in step 0201 in FIG. 2, which shows the operation of the first embodiment, so description thereof is omitted.

The operations of the policy retrieval section 20 and policy transition processor 50 in the present embodiment depicted in steps 1004 through 1005 of FIG. 10 are also the same as the operations of the policy retrieval section 20 and policy transition processor 50 depicted in steps 0203 through 0204 in FIG. 2, which show the operations of the first embodiment, so description thereof is omitted.

The operation of the policy transition processor 50 and operation execution section 30 in the present embodiment depicted in step 1009 in FIG. 10 is also the same as the operation of the policy transition processor 50 and operation execution section 30 depicted in step 1008 in FIG. 2, which shows the operation of the first embodiment, so description thereof is omitted.

As described before, in the first embodiment, the policy retrieval section 20 took all of the policies stored in the policy database 40 as targets for retrieval. In contrast, according to the fifth embodiment, the policy retrieval section 20 searches the effective flag table 42 to find all of the effective policies (step 1002), and retrieves from those policies the policy for which the trigger condition matches the event transferred from the event-receiving section 10 (step 1003).

The destination policy retrieval section 51 acquires policy-specifying information such as ID that identifies a destination policy of a policy having a policy transition (step 1006).

The destination policy retrieval section 51 then transfers to the policy addition section 522 the acquired information specifying the destination policy. The policy addition section 522 manipulates the effective flag table 42 to change the flag corresponding to the transferred information specifying the policy to “effective” (step 1007).

The destination policy retrieval section 51 then transfers to the policy deletion section 521 the information specifying the original pre-transition policy. The policy deletion section 521 manipulates the effective flag table 42 to change the flag corresponding to the received policy-specifying information to “ineffective” (step 1008).

The advantages of the fifth embodiment will next be described. According to the fifth embodiment, the processing involved in the addition and deletion of a policy in the policy database that accompanies policy transitions is executed merely by operating flags, whereby the processing load involved in the policy transition operation can be alleviated.

Embodiment 6

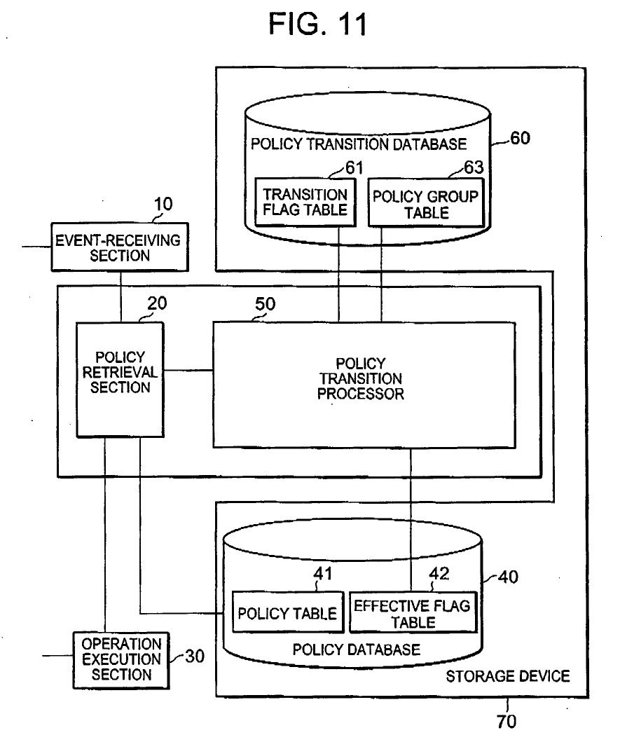

Referring to FIG. 11, the policy processing system according to a sixth embodiment of the present invention differs in that the policy database 40 has a policy table 41 and an effective flag table 42 (the same as the fifth embodiment in FIG. 9) in contrast with the configuration of the policy database 40 in the configuration of the third embodiment depicted in FIG. 5. Further, the sixth embodiment differs in that the policy transition database 60 has no destination policy table 62 in contrast with the policy transition database 60 in the third embodiment depicted in FIG. 5.

The policy table 41 stores information equivalent to the information stored in the policy database of the third embodiment. The effective flag table 42 stores a flag that indicates effectiveness or ineffectiveness for each policy.

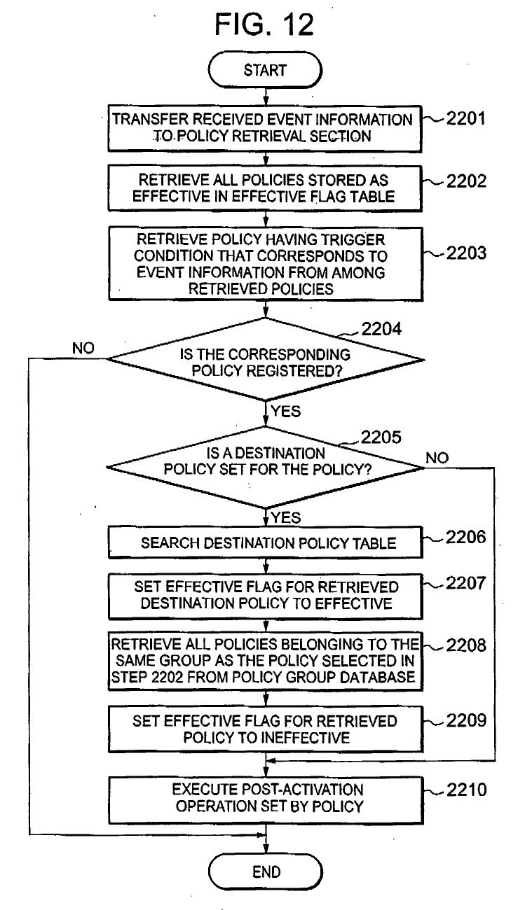

An operation of the above-mentioned sixth embodiment is depicted in FIG. 12.

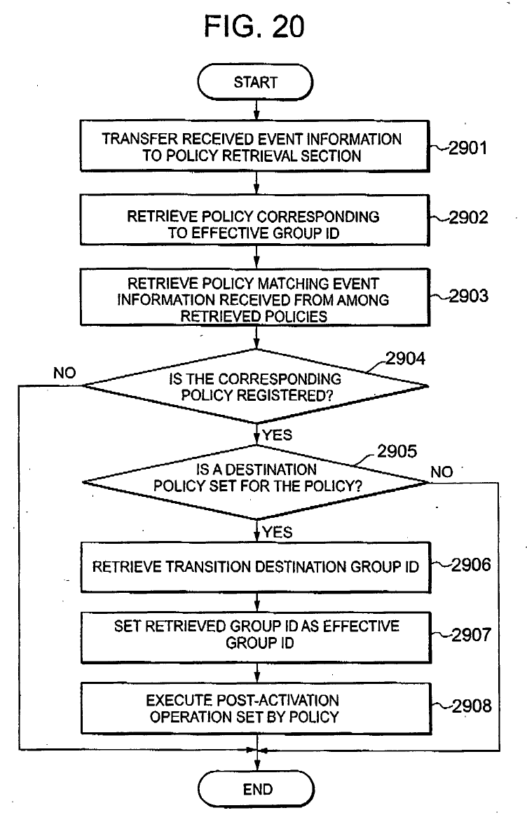

Referring to FIG. 12, the operations of the event-receiving section 10, policy retrieval section 20, operation execution section 30, and policy transition processor 50 depicted in steps 2201 through 2207 and in step 2210 in FIG. 20 are the same as the operations of the event-receiving section 10, policy retrieval section 20, operation execution section 30, and policy transition processor 50 depicted in steps 1001 through 1007 and in step 1009 in FIG. 10, which show the operation of the fifth embodiment.

The operations of the policy transition processor 50 depicted in steps 2208 and 2209 in FIG. 20 are also the same as the operations of the policy transition processor 50 depicted in steps 0608 and 0609 in FIG. 6, which shows the operation of the third embodiment.

The sixth embodiment provides the advantages obtained by combining the advantages of both the third embodiment and the fifth embodiment.

Embodiment 7

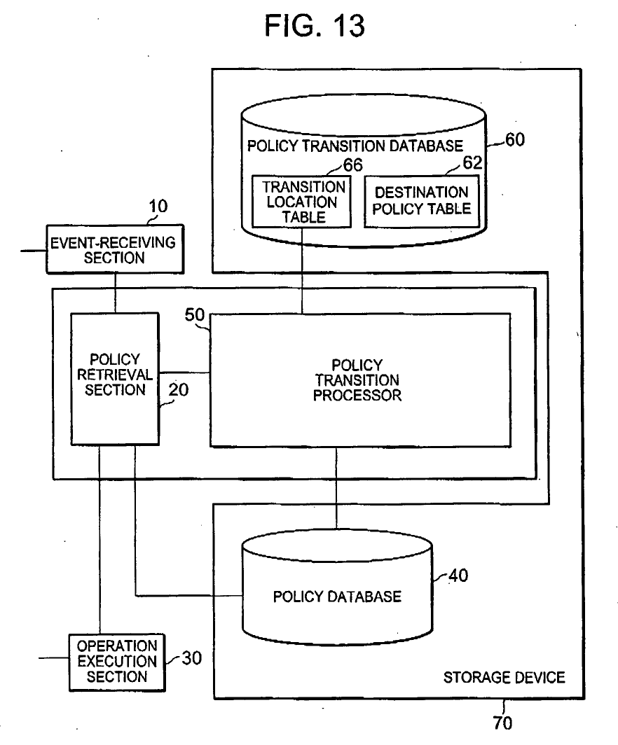

Referring to FIG. 13, the policy transition database 60 of a policy processing system according to a seventh embodiment of the present invention differs, compared to the policy transition database 60 in the first embodiment, in that the transition flag table 61 is substituted with a transition location table 66. The configuration of the policy transition processor 50 is the same as that of the first embodiment shown in FIG. 1.

In the transition location table 66 of the present embodiment, information is stored that includes a flag indicating the presence or absence of a transition for each policy; information such as ID specifying a policy as a destination policy when a transition is present; and information such as ID specifying the location of information in the destination policy table 62.

Upon receiving a policy from the policy retrieval section, the destination policy retrieval section 51 searches the transition location table 66 using that policy as a key. If the flag stored in the transition location table 66 indicates that there is a transition in that policy, the destination policy retrieval section 51 retrieves information specifying the policy and information specifying the location of information stored in the destination policy table 62, searches the destination policy table 62 using this information as a key to find a destination policy that is the transition destination.

Compared with FIG. 2 depicting the operation of the first embodiment, the operation of the seventh embodiment differs only in that the object to be searched by the destination policy retrieval section 51 is the transition location table 66 rather than the transition flag table, so a detailed description thereof is omitted.

The advantages of the above-mentioned seventh embodiment will next be described. According to the present embodiment, when policies having the same trigger condition and the same post-activation operation appear in a plurality of locations during policy transition, the necessary storage capacity of the policy transition database can be reduced by dealing with these policies as a single policy.

Embodiment 8

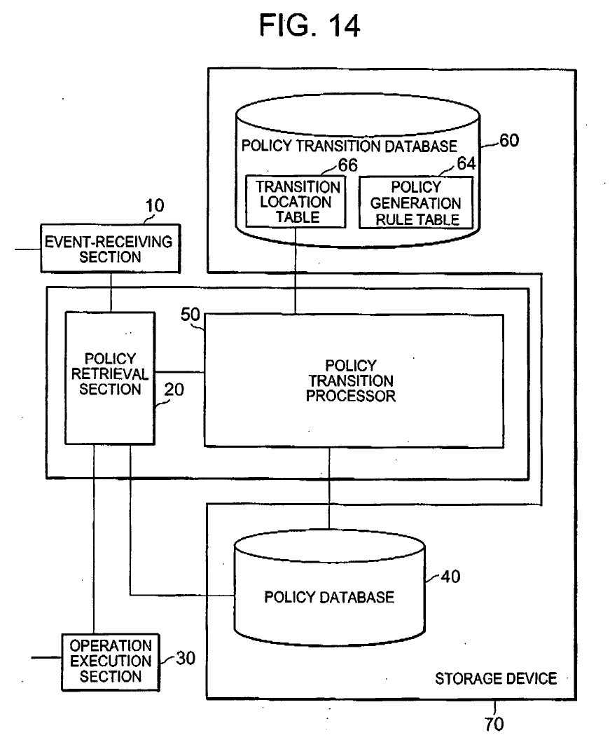

Referring to FIG. 14, in a policy processing system according to an eighth embodiment of the present invention, compared to the policy transition database 60 in the second embodiment depicted in FIG. 3, the policy transition database 60 differs in that the transition flag table 61 is substituted with a transition location table 66. The configuration of the policy transition processor 50 is the same as that of the second embodiment as shown in FIG. 3.

In the transition location table 66 thus configured, information is stored that includes a flag indicating the presence or absence of a transition for each policy; information such as ID specifying a policy as a destination policy when a transition is present; and information such as ID specifying the location of information in the policy generation rule table 64.

Upon receiving a policy from the policy retrieval section 20, the destination policy retrieval section 51 searches the transition location table 66 using that policy as a key. If a flag stored in the transition location table 66 indicates that there is a transition in that policy, the destination policy retrieval section 51 retrieves information specifying the policy and information specifying the location of information stored in the policy generation rule table 64, searches the policy generation rule table 64 using this information as a key to find a policy that is the transition destination.

An operation of the eighth embodiment differs from FIG. 4 depicting the operation of the second embodiment only in that an object to be searched by the destination policy retrieval section 51 is the transition location table 66 rather than the transition flag table, so a detailed description thereof is omitted.

The eighth embodiment has the advantages obtained by combining the advantages of both the second embodiment and the seventh embodiment.

Embodiment 9

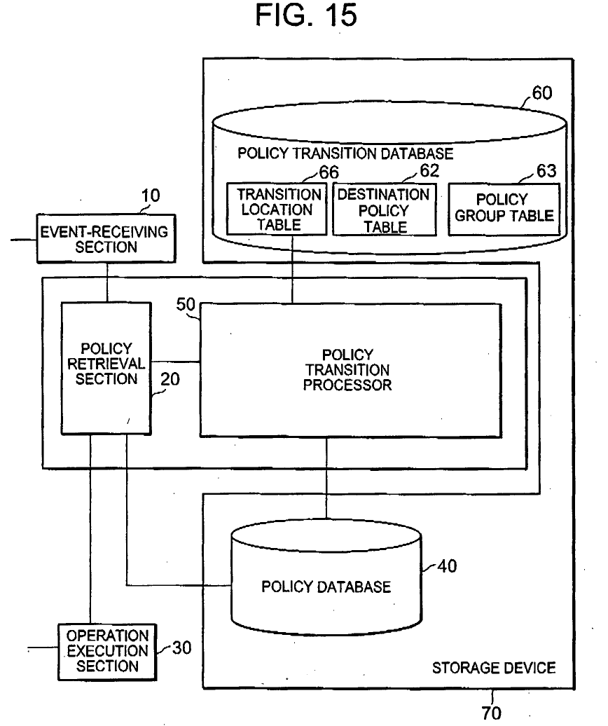

Referring to FIG. 15, in a policy processing system according to a ninth embodiment of the present invention, in comparison to the policy transition database 60 in the third embodiment depicted in FIG. 5, the policy transition database 60 differs in that the transition flag table 61 is substituted with a transition location table 66. The configuration of the policy transition processor 50 is the same as that of the third embodiment as shown in FIG. 5.

In the transition location table 66 of the present embodiment, information is stored that includes a flag indicating the presence or absence of a transition for each policy; information such as ID specifying a policy as the destination policy when a transition is present; and information such as ID specifying the location of information stored in the destination policy table.

Upon receiving a policy from the policy retrieval section 20, the destination policy retrieval section 51 searches the transition location table 66 using that policy as a key. If the flag stored in the transition location table 66 indicates that there is a transition in that policy, then the S destination policy retrieval section 51 retrieves information specifying the policy and information specifying the location of information stored in the destination policy table 62, searches the destination policy table 62 using this information as a key to find a policy that is the transition destination.

An operation of the ninth embodiment differs from FIG. 6, which shows the operation of the third embodiment, only in that an object searched by the destination policy retrieval section 51 is the transition location table 66 rather than the transition flag table, so a detailed description thereof is omitted.

The ninth embodiment has the advantage's obtained by combining the advantages of both the third embodiment and the seventh embodiment.

Embodiment 10

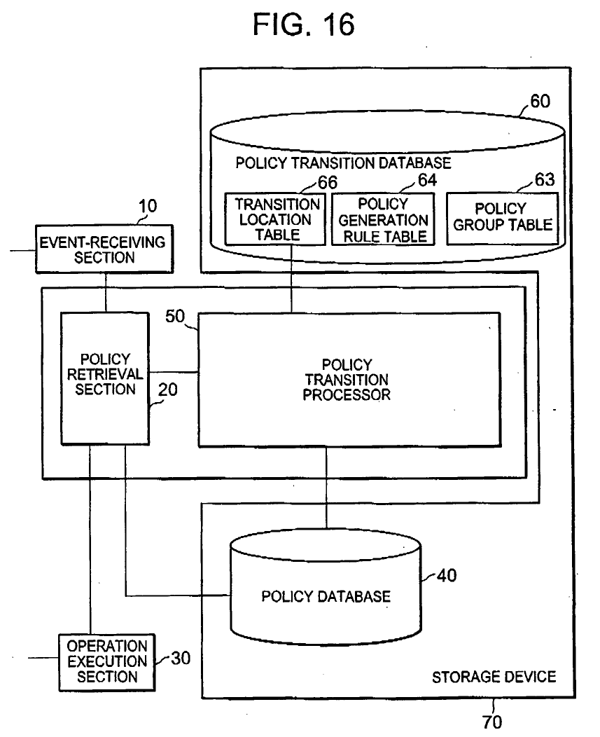

Referring to FIG. 16, in a policy processing system according to a tenth embodiment of the present invention, in comparison to the policy transition database 60 in the fourth embodiment depicted in FIG. 7, the policy transition database 60 differs in that the transition flag table 61 is substituted with a transition location table 66. The configuration of the policy transition processor 50 is the same as that of the fourth embodiment as shown in FIG. 7.

In the transition location table 66 thus configured, information is stored that includes a flag indicating the presence or absence of a transition for each policy; information such as ID specifying a policy as the destination policy when a transition is present; and information such as ID specifying the location of information stored in the policy generation rule table 64.

Upon receiving a policy from the policy retrieval section, the destination policy retrieval section 51 searches the transition location table 66 using that policy as a key. If the flag stored in the transition location table 66 indicates that there is a transition in that policy, the destination policy retrieval section 51 retrieves information specifying the policy and information specifying the location of information stored in the policy generation rule table 64, searches the destination policy table 62 using this information as a key to find a policy that is the transition destination.

An operation of the tenth embodiment differs from FIG. 8 depicting the operation of the fourth embodiment only in that an object to be searched by the destination policy retrieval section 51 is the transition location table 66 rather than the transition flag table, so a detailed description thereof is omitted.

The tenth embodiment has the advantages obtained by combining the advantages of both the fourth embodiment and the seventh embodiment.

Embodiment 11

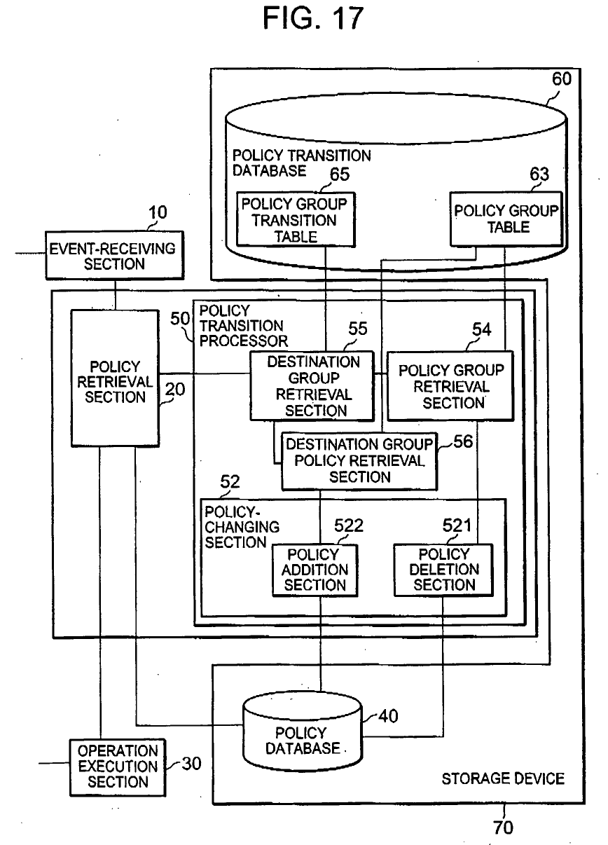

Referring to FIG. 17, in a policy processing system according to an eleventh embodiment of the present invention, in comparison to the third embodiment depicted in FIG. 5, the policy transition processor 50 differs in not having the destination policy retrieval section 51, in being provided with a destination group retrieval section 55 and a destination group policy retrieval section 56, and in that the transition flag table 61 of the policy transition database 60 is substituted with a policy group transition table 65.

The policy group transition table 65 in the present embodiment retains a flag for indicating for each policy whether or not a transition will occur after activation of a policy, and a group ID for specifying the destination policy to which a transition will be made after activation of the policy.

Upon receiving a policy from the policy retrieval section 20, the destination group retrieval section 55 searches the policy group transition table 65 using that policy as a key and inquires whether or not a transition has been set to occur for that policy. when a transition will occur, the group ID of the transition destination is retrieved from the policy group transition table 65, and the group ID thus retrieved is transferred to the destination group policy retrieval section 56.

The destination group policy retrieval section 56 searches the policy group table 63 using the group ID received from the destination group retrieval section 55 as a key, acquires all of the policies that have the group ID as an affiliated group, and transfers all of the policies thus retrieved to the policy addition section 522.

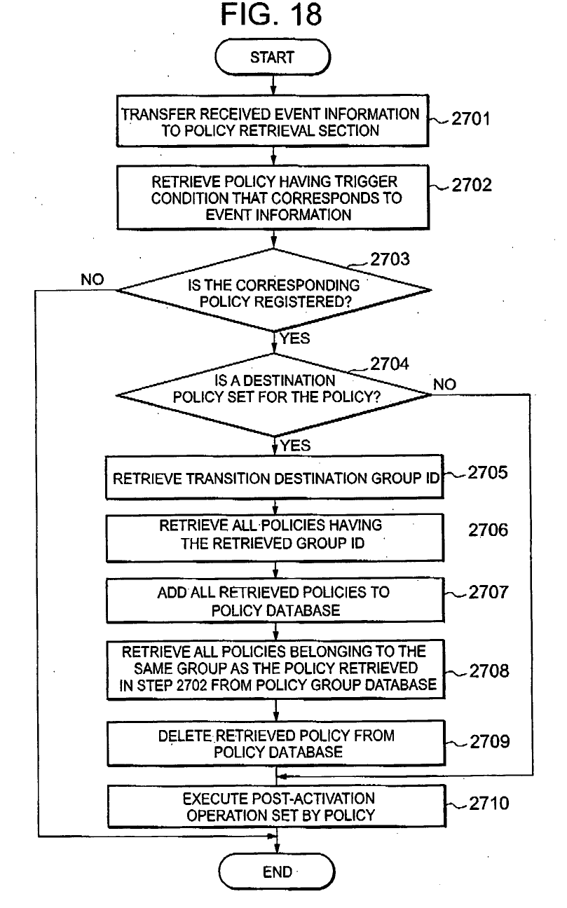

An operation of the eleventh embodiment will next be described in detail with reference to FIG. 18.

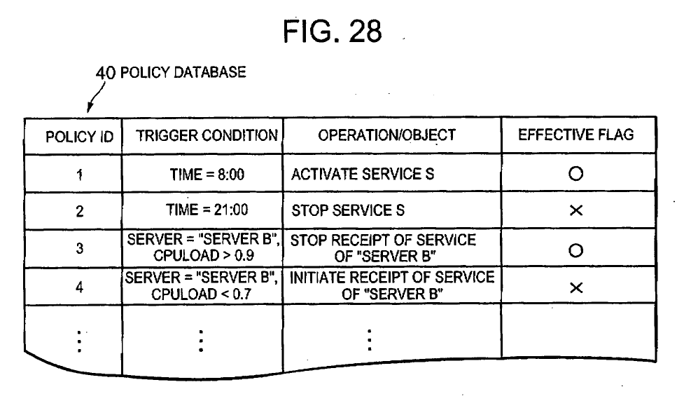

Referring to FIG. 18, the operations of the event-receiving section 10, policy retrieval section 20, operation execution section 30, and policy transition processor 50 depicted in steps 2701 through 2703 and in steps 2708 through 2710 in FIG. 28 are the same as the operations of the event-receiving section 10, policy retrieval section 20, operation execution section 30, and policy transition processor 50 depicted in steps 0601 through 0603 and in steps 0607 through 0609 in FIG. 10, which shows the operation of the third embodiment.

The activated policy is transferred from the destination policy retrieval section 51 to the destination group retrieval section 55.

The destination group retrieval section 55 searches the policy group transition table 65 using that policy as a key and inquires whether or not a transition has been set to occur for that policy (step 2704). When a transition will occur (YES in step 2704), the group ID of the transition destination is retrieved from the policy group transition table 65 (step 2705).

Subsequently, the destination group retrieval section 55 transfers the group ID thus retrieved to the destination group policy retrieval section 56. The destination group policy retrieval section 56 searches the policy group table 63 using the group ID as a key, acquires all of the policies that have the group ID as an affiliated group, and transfers all of the policies thus retrieved to the policy addition section 522 (step 2706). The policy addition section 522 adds all of the policies thus received to the. policy database 40 (step 2707).

According to the above-mentioned eleventh embodiment, the aggregate of transition destination and transition origin policies can be managed as a group, thereby making it easy to manage a transition under circumstances in which a plurality of policies are present that makes transition to the same combination of policies, circumstances in which a combination of destination policies is changed, or the like.

Embodiment 12

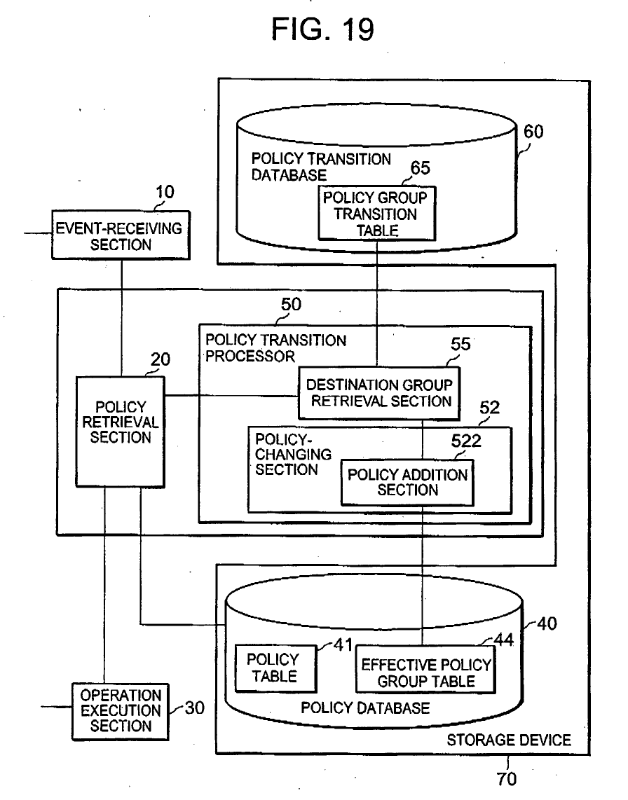

Referring to FIG. 19, in a policy processing system according to a twelfth embodiment of the present invention, in comparison to the eleventh embodiment depicted in FIG. 17, the policy transition processor 50 differs in that the policy transition processor 50 does not have a destination group policy retrieval section 56, policy group retrieval section 54, or policy deletion section 521, that the policy database 40 has a policy table 41 and an effective policy group table 44, and that the policy transition database 60 has no policy group table 63.

The policy table 41thus configured stores the information held by the policy database 40 of the eleventh embodiment.

The effective policy group table 44 stores an effective group ID, which is the group ID currently in effect, and a group ID corresponding to each policy.

Upon receiving a policy from the policy retrieval section, the destination group retrieval section 55 searches the policy group transition table 65 using that policy as a key, inquires whether or not there is a transition for that policy, retrieves the group ID of the group that will be the transition destination when a transition will occur, and transfers the group ID to the policy addition section 522.

The policy addition section 522 rewrites the effective group ID of the effective policy group table 44 into the group ID received from the destination group retrieval section 55, The policy retrieval section 20 acquires the effective group ID of the effective policy group table 44, references the effective policy group table 44 using that effective group ID as a key, and retrieves all of the policies that correspond to the same group ID as the effective group ID. Subsequently, the trigger conditions of those policies are retrieved from the policy table 41, and policies are retrieved that have trigger conditions that match the event.

An operation of the twelfth embodiment will next be described in detail with reference to FIG. 20.

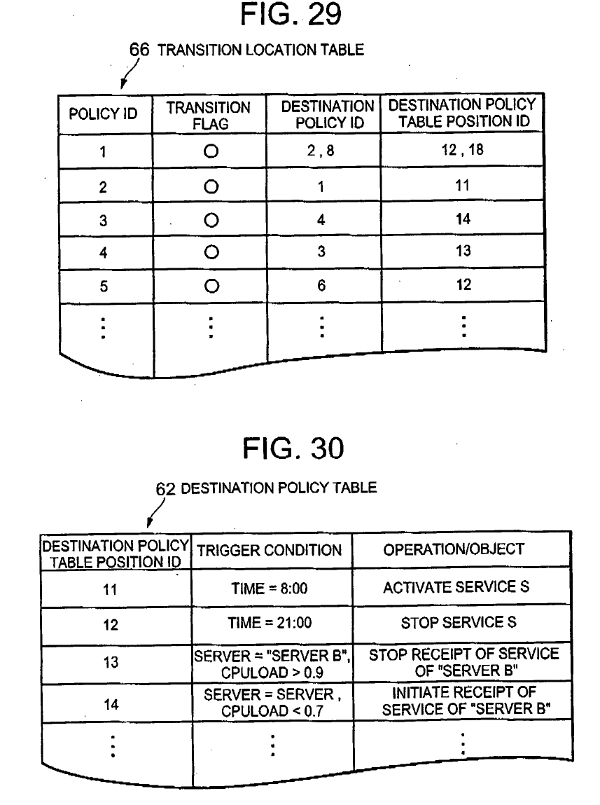

Referring to FIG. 20, the operations of the event-receiving section 10, policy retrieval section 20, operation execution section 30, and policy transition processor 50 depicted in steps 2901, 2904 through 2906, and 2908 in FIG. 30 are the same as the operations of the event-receiving section 10, policy retrieval section 20, operation execution section 30, and policy transition processor 50 depicted in steps 2701, 2703 through 2705, and 2710 in FIG. 28, which show the operations of the eleventh embodiment, so description thereof is omitted.

Upon receiving an event from the event-receiving section 10, the policy retrieval section 20 acquires the effective group ID of the effective policy group table 44, references the effective policy group table 44 using that effective group ID as a key, and retrieves all of the policies that correspond to the same group ID as the effective group ID (step 2902).

Thereafter, the trigger conditions and post-activation operations of the policies thus retrieved are retrieved from the policy table 41, and the policy having a trigger condition that matches the received event is retrieved from among those policies (step 2903).

The destination group retrieval section 55 transfers to the policy addition section 522 the group ID thus retrieved. The policy addition section 522 rewrites the effective group ID of the effective policy group table 44 into the group ID received from the destination group retrieval section 55 (step 2907).

According to the above-mentioned twelfth embodiment, in addition to the advantages of the eleventh embodiment, the processing during a policy transition can be executed simply by rewriting the effective group ID, so the processing load required for a policy transition can be alleviated.

Embodiment 13

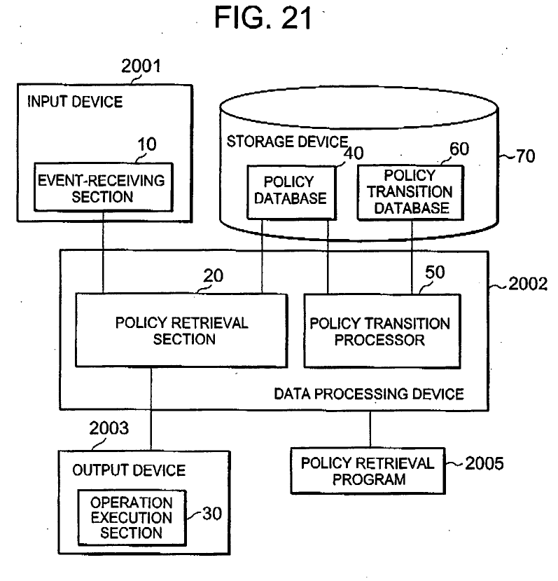

Referring to FIG. 21, in a policy processing system according to a thirteenth embodiment of the present invention is provided with an input device 2001, a data processing device 2002, a storage device 70, and an output device 2003.

The data processing device 2002 may be realized by a CPU that can be controlled by a program, and can perform the above-described operation as described in the first to twelfth embodiments by executing an appropriate policy retrieval program 2005. The policy retrieval program 2005 maybe stored on a magnetic disk, semiconductor memory, or other recording medium, is loaded into a memory of the data processing device 2002 from the recording medium, and is caused to perform various functions by controlling the operations of a processor.

The policy retrieval program 2005 runs on the data processing device 2002 to control the operation of the data processing device 2002 and to generate the policy database 40 and the policy transition database 60 in the storage device 70.

Under the control of the policy retrieval program 2005, the data processing device 2002 executes processing that is identical to the processing executed by the policy retrieval section 20 and the policy transition processor 50 in the first to twelfth embodiments, executes the operation of the event-receiving section 10 in the input device 2001, and executes the operation of the operation execution section 30 in the output device 2003.

### EXAMPLE 1

A working example 1 corresponding to the first embodiment as shown in FIG. 1 will next be described with reference to the drawings.

In the present working example, a personal computer is used as the policy retrieval section 20 and the policy transition processor 50; a hard disk is used as the policy database 40 and the policy transition database 60; and an interface with a network is used as the event-receiving section 10 and the operation execution section 30.

In the policy database 40, a policy ID number is assigned to each policy related to trigger condition and post-activation operation. The trigger condition specifies an event with a certain range. Examples thereof include “time=8:00,” which means “when it is 8:00 am”; “authorized=true, request =‘service A’,” which means “when there is a request to use service A from an authorized user”; “server=‘server B’, cpuload 0.9,” which means “when the load of server B is 0.9 or higher”; and the like.

The post-activation operation is an operation performed by the operation execution section when a policy is activated by means of an event occurring in which the policy matches the trigger condition. This operation specifies what type of message to send to which address. Examples of this post-activation operation include “issue request to stop application provided by server C,” “issue request to mirror the service of server B in server D,” and the like.

The policy transition database 60 stores trigger conditions and post-activation operations for all policy IDs. Also stored are a flag indicating whether or not a destination policy is present for each policy ID, and the policy ID of the destination policy when the flag indicates that a transition destination is present.

A transition flag table 61 in the policy transition database 60 provides the presence or absence of a destination policy for each of the policy IDs contained in the policy database 40 and the policy IDs of the destination policies in the destination policy table 62. A trigger condition and a post-activation operation are also stored in the destination policy table 62 for all policy IDs contained in the destination policies of the transition flag table 61.

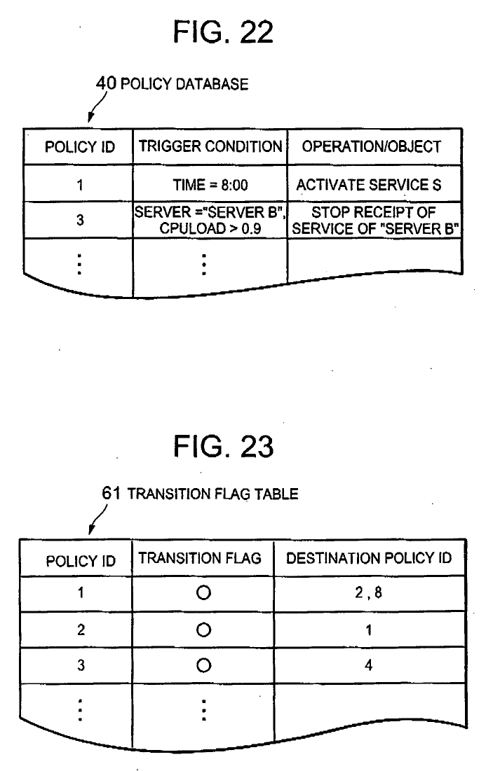

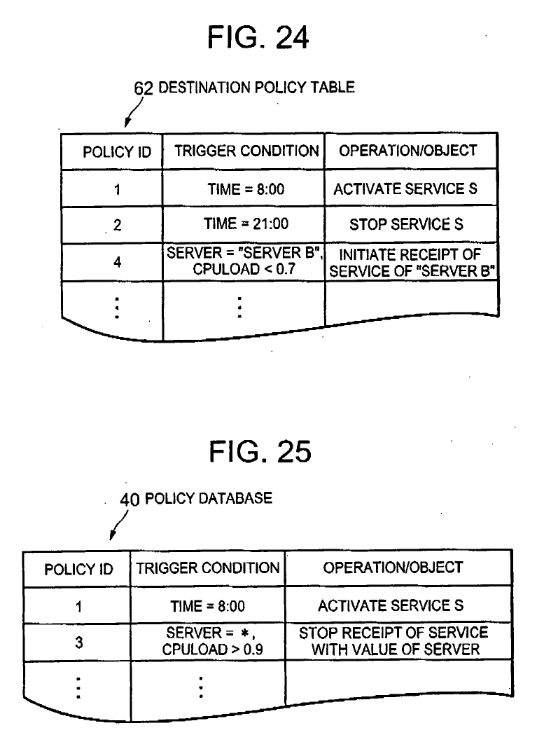

An example of the format of the policy database 40 is depicted in FIG. 22; an example of the format of the transition flag table 61 is depicted in FIG. 23; and an example of the format of the destination policy table 62 is depicted in FIG. 24.

In the present example, the event information “server=‘server B’, cpuload 0.95” indicating that “the load of server B is 0.95” has been sent to the event-receiving section 10.

The policy retrieval section 20 retrieves from the policy database 40 a policy having a trigger condition that matches this event. A policy having the trigger condition “server=‘server B’, cpuload 0.9” coincides with this condition in the present working example.

Accordingly, the policy retrieval section 20 transfers the policy ID “3” held by this policy to the destination policy retrieval section 51 of the policy transition processor 50. The destination policy retrieval section 51 searches the transition flag table 61 of the policy transition database 60 using the policy ID “3” as a key. In this case, the flag indicates that a policy transition destination is present, so the policy ID of the destination policy is obtained from the transition flag table 61. In this case, it is found that the policy ID “4” is the destination policy.

The destination policy table 62 of the policy transition database 60 is then searched using the policy ID “4” of the destination policy thus obtained as a key. The policy in this case has the trigger condition “server=‘server B’, cpuload<0.7,” and also has the post-activation operation “initiate receipt of server B service.”

The destination policy retrieval section 51 then transfers to the policy deletion section 521 the policy ID “3” of the original pre-transition policy. The policy deletion section 521 searches the policy database 40 using the policy ID “3” thus transferred as a key, and deletes the corresponding policy from the policy database 40.

The destination policy retrieval section 51 then transfers to the policy addition section 522 information about the destination policy thus retrieved, that is, the transition condition “server=‘server B’, cpuload<0.7,” the post-activation operation “initiate receipt of server B service,” and the policy ID “4.” The policy addition section 522 adds to the policy database the policy thus transferred.

The policy retrieval section 20 then transfers to the operation execution section 30 the post-activation operation “send message for stopping receipt of the server B service” for the retrieved policy. The operation execution section 30 sends a message to server B to stop receipt of the service.

### EXAMPLE 2

A working example 2 corresponding to the second embodiment as shown in FIG. 3 will next be described with reference to the drawings.

The present working example has the same configuration as the above-mentioned Working Example 1, but the processor of the personal computer also functions as the destination policy generator 53 and has a policy generation rule table 64 instead of the destination policy table 62 in its hard disk.

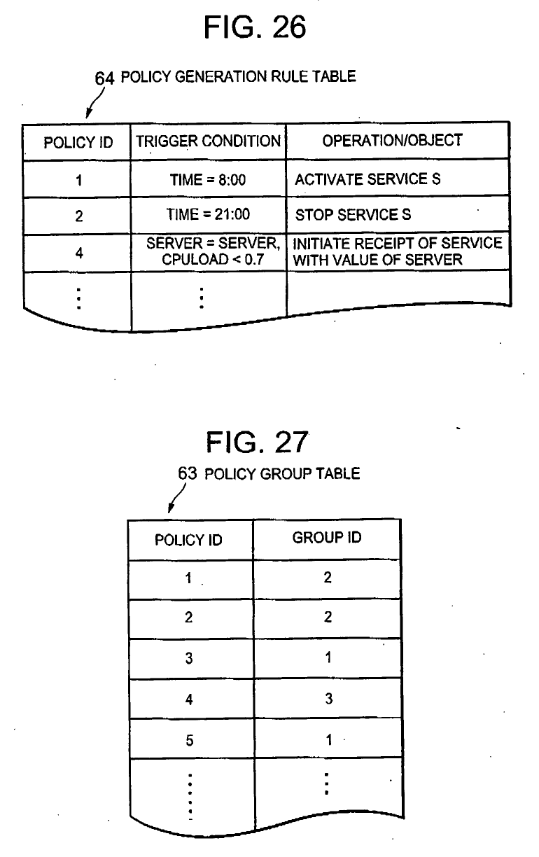

An example of the format of the policy database 40 in the present working example is depicted in FIG. 25, and an example of the format of the policy generation rule table 64 is depicted in FIG. 26.

In the present example, the event “server=‘server B’, cpuload=0.95” indicating that “the load of server B is 0.95” has been sent to the event-receiving section 10.

The policy retrieval section 20 retrieves from the policy database a policy having a trigger condition that matches this event. A policy having the trigger condition “server=cpuload 0.9,” which is a trigger condition that means “when the load of any of the servers is 0.9 or above,” coincides with this condition in the present working example.

The policy retrieval section 20 then transfers the policy ID “3” held by this policy to the destination policy retrieval section 51 of the policy processing unit. The destination policy retrieval section 51 searches the transition flag table 61 of the policy transition database 60 with the policy ID “3” as a key. In this case, the flag indicates that a policy transition destination is present, so the policy ID of the destination policy is obtained from the transition flag table 61. The policy ID “4” becomes the destination policy in this case.

The destination policy generator 53 then searches the policy generation rule table 64 of the policy transition database 60 using the policy ID “4” of the destination policy thus obtained as a key. The policy generation rules in this case are the rule for generating the trigger condition “server server, cpuload<0.7,” and the rule for generating the post-activation operation “initiate receipt of service with the server value.”

Subsequently, the destination policy generator 53 generates a policy on the basis of the policy generation rules thus obtained and on the basis of the event “server=‘server B’, cpuload=0.95.” The “server” value in this case is “server B,” so the newly generated policy has the trigger condition “server ‘server B’, cpuload<0.7,” which means “when the load of server B is 0.7 or lower,” and has the post-activation operation “set server B to accept service receipt.”

The destination policy retrieval section 51 then transfers to the policy deletion section 521 the policy ID “3” of the original pre-transition policy. The policy deletion section 521 searches the policy database 40 with the policy ID “3” thus transferred as a key, and deletes the corresponding policy from the policy database 40.

The destination policy generator 53 then transfers to the policy addition section 522 the policy ID “4” and information about the policy thus generated. The policy addition section 522 adds to the policy database 40 the policy thus transferred.

### EXAMPLE 3

A working example 3 corresponding to the third embodiment as shown in FIG. 5 will next be described with reference to the drawings.

The present working example has the same configuration as the above-mentioned Working Example 1, but the processor of the personal computer also functions as the policy group retrieval section 54, and has a policy group table 63 in its hard disk. An example of the format of the policy group table 63 is depicted in FIG. 27.

In the present example, the event information “server=‘server B’, cpuload=0.95” indicating that “the load of server B is 0.95” has been sent to the event-receiving section 10.

The policy retrieval section 20 retrieves from the policy database 40 a policy having a trigger condition that matches this event. A policy having the trigger condition “server=*, cpuload 0.9” coincides with this condition in the present working example.

The policy retrieval section 20 then transfers the policy ID “3” held by this policy to the destination policy retrieval section 51 of the policy transition processor 50.

The destination policy retrieval section 51 searches the transition flag table 61 of the policy transition database 60 using the policy ID “3” as a key. In this case, the flag indicates that a policy transition destination is present, so the policy ID of the destination policy is obtained from the transition flag table 61. The policy ID “4” becomes the destination policy in this case.

The destination policy retrieval section 51 then transfers to the policy group retrieval section 54 the policy ID “3” of the original pre-transition policy.

The policy group retrieval section 54 then searches the policy group table 63 using the policy ID “13” thus transferred as a key. In this working example, the policy group table is referenced with the policy ID “3,” whereupon the policy group ID “1” is obtained.

The policy group table 63 is then searched with the policy group ID “1,” whereupon policy IDs “3” and “5” are obtained.

The policy group retrieval section 54 transfers the policy IDs “3” and “5” to the policy deletion section 521. The policy deletion section 521 deletes from the policy database 40 the policy IDs “3” and “5” thus received.

The destination policy retrieval section 51 then transfers to the policy addition section 522 information about the destination policy thus retrieved, which are the transition condition “server=‘server B’, cpuload<0.7,” the post-activation operation “initiate receipt of server B service,” and the policy ID “4.” The policy addition section 522 adds to the policy database 40 the policy thus transferred.

### EXAMPLE 4

A working example 4 corresponding to the fourth embodiment as shown in FIG. 7 will next be described with reference to the drawings.

The present working example has the same configuration as the above-mentioned Working Example 2, but the processor of the personal computer also functions as the policy group retrieval section 54, and has a policy group table 63 in its hard disk. An example of the format of the policy group table 63 is depicted in FIG. 27.

In the present example, the event information “server=‘server B’, cpuload=0.95” indicating that “the load of server B is 0.95” has been sent to the event-receiving section 10.

The policy retrieval section 20 retrieves from the policy database 40 a policy having a trigger condition that matches this event. A policy having the trigger condition “server=*, cpuload 0.9” coincides with this condition in the present working example.

The policy retrieval section 20 then transfers the policy ID “3” held by this policy to the destination policy retrieval section 51 of the policy transition processor 50.

The destination policy retrieval section 51 searches the transition flag table 61 of the policy transition database 60 using the policy ID “3” as a key. In this case, the flag indicates that a policy transition destination is present, so the policy ID of the destination policy is obtained from the transition flag table 61. The policy ID “4” becomes the destination policy in this case.

The destination policy generator 53 then references the policy generation rule table 64 of the policy transition database 60 using the policy ID “4” of the destination policy thus obtained as a key. The policy in this case has the rule “server=server, cpuload<0.7” for generating a trigger condition using the server value given as an event, and the rule “initiate receipt of service with the server value” for generating a post-activation operation using the server value given as an event.

The destination policy generator 53 then generates a policy on the basis of the policy generation rules thus obtained and on the basis of the event information “server=server B′, cpuload=0.95.” The “server” value in this case is “server B,” so the newly generated policy has the trigger condition “server=‘server B’, cpuload<0.7,” which means “when the load of server B is 0.7 or lower,” and has the post-activation operation “initiate receipt of service by server B.”

The destination policy retrieval section 51 then transfers to the policy group retrieval section 54 the policy ID “3” of the original pre-transition policy. The policy group retrieval section 54 references the policy group table 63 using the policy ID “3” thus transferred as a key. In this working example, the policy group table 63 is referenced with the policy ID “3,” whereupon the policy group ID “1” is obtained.

The policy group table 63 is then searched with the policy group ID “1,” whereupon policy IDs “2” and “3” are obtained.

The policy group retrieval section 54 transfers the policy IDs “2” and “3” to the policy deletion section 521. The policy deletion section 521 deletes from the policy database 40 the policy IDs “2” and “3” thus received.

The destination policy generator 53 then transfers to the policy addition section 522 the policyID “4” and information about the policy thus generated. The policy addition section 522 adds to the policy database 40 the policy thus transferred.

### EXAMPLE 5

A working example 5 corresponding to the fifth embodiment as shown in FIG. 9 will next be described with reference to the drawings.

The present working example has the same configuration as the above-mentioned Working Example 1, but the policy database 40 has an effective flag table 42 for indicating effectiveness or ineffectiveness for each policy, and is also devoid of the destination policy table 62. An example of the format of the policy database 40 is depicted in FIG. 28.

In the present example, it is assumed that the event information “server=‘server B’, cpuload=0.95” indicating that “the load of server B is 0.95” has been sent to the event-receiving section 10.

The policy retrieval section 20 retrieves from the policy database 40 a policy having a trigger condition that matches this event from among policies that are indicated by the flag as being effective. A policy having the trigger condition “server=‘server B’, cpuload 0.9” has an effective flag, and therefore coincides with this condition in the present working example.

The policy retrieval section 20 then transfers the policy ID “3” held by this policy to the destination policy retrieval section 51 of the policy transition processor 50. The destination policy retrieval section 51 references the transition flag table 61 of the policy transition database 60 using the policy ID “3” as a key. In this case, the flag indicates that a policy transition destination is present, so the policy ID of the destination policy is obtained from the transition flag table. The policy ID “4” becomes the destination policy in this case.

The destination policy retrieval section 51 then transfers to the policy deletion section 521 the policy ID “3” transferred from the policy retrieval section 20. The policy deletion section 521 retrieves the policy with the policy ID “3” from the policy database 40, removes the effective flag thereof to exclude it as a target for retrieval.

The destination policy retrieval section 51 then transfers to the policy addition section 522 the policy ID “3” retrieved as the destination policy. The policy addition section 522 retrieves the policy with the policy ID “4” from the policy database 40 and sets the effective flag thereof.

### EXAMPLE 6

A working example 6 corresponding to the seventh embodiment as shown in FIG. 13 will next be described with reference to the drawings.

The present working example has the same configuration as the above-mentioned Working Example 1, but the hard disk has a transition location table 66 and a destination policy table 62. An example of the format of the transition location table 66 is depicted in FIG. 29, and an example of the format of the destination policy table is depicted in FIG. 30.

In the present example, the event information “server=‘server B’, cpuload=0.95” indicating that “the load of server B is 0.95” has been sent to the event-receiving section 10.

The policy retrieval section 20 retrieves from the policy database 40 a policy having a trigger condition that matches this event. A policy having the trigger condition “server=‘server B’, cpuload 0.9” coincides with this condition in the present working example.

The policy retrieval section 20 then transfers the policy ID “3” held by this policy to the destination policy retrieval section 51 of the policy processing unit.

The destination policy retrieval section 51 references the transition location table 66 using the policy ID “3” as a key. In this case, the flag indicates that a policy transition destination is present, so the policy ID “4” of the destination policy is obtained from the transition location table 66, and the destination policy table position ID “14” is obtained, which is the ID for specifying the policy in the destination policy table 62.

The destination policy table 62 of the policy transition database 60 is then referenced using the destination policy table position ID “14” thus obtained as a key. The policy in this case has the trigger condition “server=‘server B’, cpuload<0.7,” and also has the post-activation operation “initiate receipt of server B service.”

The destination policy retrieval section 51 then transfers to the policy deletion section 521 the policy ID “3” of the original pre-transition policy. The policy deletion section 521 searches the policy database with the policy ID “3” thus transferred as a key, and deletes the corresponding policy from the policy database.

The destination policy retrieval section 51 then transfers to the policy addition section 522 information about the destination policy thus retrieved, which are the transition condition “server=‘server B’, cpuload<0.7,” the post-activation operation “initiate receipt of server B service,” and the policy ID “4.” The policy addition section 522 adds to the policy database 40 the policy thus transferred.

The present invention was described above using preferred embodiments and working examples, but the present invention is not necessarily limited by the above-mentioned embodiments and working examples. Various modifications may be made thereto within the technical scope of the present invention.

1. A policy processing system comprising:
a storage section for storing a plurality of policies, wherein each of the plurality of policies includes policy transition information including at least one transition-destination policy for a corresponding policy; and
a policy transition processor performing policy transition such that, when a policy is activated due to occurrence of an event that matches the policy, the policy activated is changed to a corresponding transition-destination policy according to the policy transition information of the policy activated.

2. A policy processing system comprising:
a policy database for storing a trigger condition and a post-activation operation for each of a plurality of policies;
a policy transition database for storing policy transition information for a policy that is associated with at lease one transition-destination policy;
a destination policy retrieval section for retrieving from the policy transition database a transition-destination policy based on the policy transition information for a policy that is activated due to occurrence of an event that matches a trigger condition of the policy; and
a policy-changing section for changing the policy activated to the transition-destination policy retrieved in the policy database.

3. The policy processing system according to claim 2, further comprising:
a policy retrieval section for retrieving a policy having a trigger condition matching an event from the policy database to activate the policy; and
an operation execution section for executing the post-activation operation of the policy activated.

4. The policy processing system according to claim 2, wherein the policy transition database comprises:
a transition flag table for storing transition flags for respective ones of the plurality of policies, wherein a transition flag indicates whether a corresponding policy is associated with at lease one transition-destination policy; and
a destination policy table for storing a trigger condition and a post-activation operation for each transition-destination policy.

5. The policy processing system according to claim 2, wherein the policy transition information includes a policy generation rule for generating a transition-destination policy from the policy activated.

6. The policy processing system according to claim 4, wherein the policy transition information includes a policy generation rule for generating a transition-destination policy from the policy activated.

7. The policy processing system according to claim 5, wherein the policy transition database comprises:
a transition flag table for storing transition flags for respective ones of the plurality of policies, wherein a transition flag indicates whether a corresponding policy is associated with at lease one transition-destination policy; and
a policy generation rule table for storing a policy generation rule comprising a trigger condition generation rule and a post-activation operation generation rule.

8. The policy processing system according to claim 2, wherein the policy-changing section comprises;
a policy deletion section for deleting the policy activated from the policy database; and
a policy addition section for adding the transition-destination policy retrieved to the policy database.

9. The policy processing system according to claim 2, wherein the policy transition information includes policy group information under which a plurality of policies is grouped, wherein the policy-changing section deletes a group of policies including the policy activated from the policy database.

10. The policy processing system according to claim 5, wherein the policy transition information includes policy group information under which a plurality of policies is grouped, wherein the policy-changing section deletes a group of policies including the policy activated from the policy database.

11. The policy processing system according to claim 9, wherein the policy transition database comprises a policy group table storing policy group information under which a plurality of policies is grouped,
the policy processing system further comprising a policy group retrieval section for retrieving a group of policies including the policy activated from the policy group table.

12. The policy processing system according to claim 2, wherein the policy database further stores an effectiveness flag for each of the plurality of policies, wherein among a plurality of policies having the effectiveness flag that has been set, a policy activated due to occurrence of an event that matches a trigger condition of the policy is retrieved.

13. The policy processing system according to claim 12, wherein the policy-changing section resets the effectiveness flag of the policy activated to ineffective, and sets the effectiveness flag of the transition-destination policy retrieved to effective.

14. The policy processing system according to claim 9, wherein the policy database further stores an effectiveness flag for each of the plurality of policies, wherein among a plurality of policies having the effectiveness flag that has been set, a policy activated due to occurrence of an event that matches a trigger condition of the policy is retrieved.

15. The policy processing system according to claim 2, wherein the policy transition database comprises:
a destination policy table for storing a trigger condition and a post-activation operation for each transition-destination policy; and
a transition location table for storing transition flags and transition locations for respective ones of the plurality of policies, wherein a transition flag indicates whether a corresponding policy is associated with at lease one transition-destination policy and a transition location indicates a location of at lease one transition-destination policy in the destination policy table,
wherein the trigger condition and the post-activation operation for a single transition-destination policy are usable for a plurality of policies in the transition location table.

16. The policy processing system according to claim 9, wherein the policy transition database comprises:
a destination policy table for storing a trigger condition and a post-activation operation for each transition-destination policy; and
a transition location table for storing transition flags and transition locations for respective ones of the plurality of policies, wherein a transition flag indicates whether a corresponding policy is associated with at lease one transition-destination policy and a transition location indicates a location of at lease one transition-destination policy in the destination policy table,
wherein the trigger condition and the post-activation operation for a single transition-destination policy are usable for a plurality of policies in the transition location table.

17. The policy processing system according to claim 10, wherein the policy transition database comprises:
a destination policy table for storing a trigger condition and a post-activation operation for each transition-destination policy; and
a transition location table for storing transition flags and transition locations for respective ones of the plurality of policies, wherein a transition flag indicates whether a corresponding policy is associated with at lease one transition-destination policy and a transition location indicates a location of at lease one transition-destination policy in the destination policy table,
wherein the trigger condition and the post-activation operation for a single transition-destination policy are usable for a plurality of policies in the transition location table.

18. A policy processing system comprising:
a policy database for storing a plurality of policies to be retrieved;
a policy group table storing policy group information under which a plurality of policies is grouped;
a policy group transition table storing transition-destination policy group information for a policy that is associated with at lease one transition-destination policy;
a destination group retrieval section for retrieving from the policy group transition table a transition-destination policy group based on the transition-destination policy group information for a policy that is activated due to occurrence of an event that matches the policy;
a policy group retrieval section for retrieving from the policy group table a policy group including the a policy that is activated due to occurrence of an event that matches the policy; and
a policy-changing section for changing policies belonging to the policy group retrieved to policies belonging to the transition-destination policy group retrieved in the policy database.

19. A policy processing system comprising:
a policy database for storing a plurality of policies;
an effective policy group table for storing an effective group;
a policy group transition table storing transition-destination policy group information for a policy that is associated with at lease one transition-destination policy;
a policy retrieval section for retrieving a policy that is activated due to occurrence of an event that matches the policy from the effective group of policies stored in the policy database; and
a policy changing section for changing the effective group in the effective policy group table from the group including the policy activated to a transition-destination policy group including a transition-destination policy associated with the policy activated, based on the transition-destination policy group information.

20. A computer program instructing a computer to implement a policy processing system, comprising the steps of:
storing a trigger condition and a post-activation operation for each of a plurality of policies into a policy database;
storing policy transition information for a policy that is associated with at lease one transition-destination policy into a policy transition database;
retrieving from the policy transition database a transition-destination policy based on the policy transition information for a policy that is activated due to occurrence of an event that matches a trigger condition of the policy; and
changing the policy activated to the transition-destination policy retrieved in the policy database.

21. The computer program according to claim 20, wherein the policy transition information includes a policy generation rule for generating a transition-destination policy from the policy activated.

22. The computer program according to claim 21, wherein the policy transition information is stored by:
storing transition flags for respective ones of the plurality of policies, wherein a transition flag indicates whether a corresponding policy is associated with at lease one transition-destination policy; and
storing a policy generation rule comprising a trigger condition generation rule and a post-activation operation generation rule.

23. The computer program according to claim 20, wherein the policy transition information includes policy group information under which a plurality of policies is grouped, wherein a group of policies including the policy activated is deleted from the policy database.

24. The computer program according to claim 20, further comprising the step of:
storing an effectiveness flag for each of the plurality of policies into the policy database, wherein among a plurality of policies having the effectiveness flag that has been set, a policy activated due to occurrence of an event that matches a trigger condition of the policy is retrieved.

25. A policy processing method comprising:
storing a trigger condition and a post-activation operation for each of a plurality of policies into a policy database;
storing policy transition information for a policy that is associated with at lease one transition-destination policy into a policy transition database;
retrieving from the policy transition database a transition-destination policy based on the policy transition information for a policy that is activated due to occurrence of an event that matches a trigger condition of the policy; and
changing the policy activated to the transition-destination policy retrieved in the policy database.

26. The policy processing method according to claim 25, wherein the policy transition information includes a policy generation rule for generating a transition-destination policy from the policy activated.

27. The policy processing method according to claim 26, wherein the policy transition information is stored by:
storing transition flags for respective ones of the plurality of policies, wherein a transition flag indicates whether a corresponding policy is associated with at lease one transition-destination policy; and
storing a policy generation rule comprising a trigger condition generation rule and a post-activation operation generation rule.

28. The policy processing method according to claim 25, wherein the policy transition information includes policy group information under which a plurality of policies is grouped, wherein a group of policies including the policy activated is deleted from the policy database.

29. The policy processing method according to claim 25, further comprising the step of:
storing an effectiveness flag for each of the plurality of policies into the policy database, wherein among a plurality of policies having the effectiveness flag that has been set, a policy activated due to occurrence of an event that matches a trigger condition of the policy is retrieved.
